(19) United States
(12) Patent Application Publication
(10) Pub. No.: US 2026/0241332 A1
(43) Pub. Date: Aug. 20, 2026

(54) POROUS ADSORPTION MATERIAL FOR REMOVING NEON FROM HELIUM AND PREPARATION METHOD THEREOF

(71) Applicants: Guangzhou Guanggang Gases & Energy Co., Ltd., Guangzhou (CN); South China University of Technology, Guangzhou (CN)

(72) Inventors: Tao DENG, Guangzhou (CN); Jixiong LIU, Guangzhou (CN); Fei TENG, Guangzhou (CN); Xianlin LIU, Guangzhou (CN); Qibin XIA, Guangzhou (CN); Haoyuan LUO, Guangzhou (CN); Zhong LI, Guangzhou (CN)

(21) Appl. No.: 19/536,356

(22) Filed: Feb. 11, 2026

(30) Foreign Application Priority Data
Feb. 18, 2025 (CN) 202510174019.6

(51) Int. Cl. B01D 53/22; B01D 53/02; B01D 53/04; B01J 20/02; B01J 20/20; B01J 20/28

(52) U.S. Cl. CPC B01D 53/229; B01D 53/02; B01D 53/0462; B01J 20/0237; B01J 20/20; B01J 20/28016; B01D 2253/108; B01D 2253/308

(57) ABSTRACT

A porous adsorption material for removing neon from helium and a preparation method thereof are provided. The method includes the following steps. (1) Preparing a fermented lignin raw material. (2) Preparing a carbon precursor. (3) Stirring and impregnating the carbon precursor in a mixed solution containing a metal salt and a surfactant to obtain a metal salt-impregnated carbon precursor. (4) Washing the metal salt-impregnated carbon precursor to remove an excess deposited metal salt and drying to obtain a washed carbon precursor. (5) Activating the washed carbon precursor with carbon dioxide to effect pore formation at a high temperature to obtain the porous adsorption material for removing neon from helium. The porous carbon adsorption material prepared from renewable natural biomass raw materials has uniformly distributed pore size structure. It exhibits a high adsorption and capture capacity for neon under low-temperature conditions and effectively remove neon impurities from helium.

### CROSS-REFERENCE TO RELATED APPLICATION

This application claims priority to Chinese Patent Application No. 202510174019.6, filed Feb. 18, 2025, which is herein incorporated by reference in its entirety.

### TECHNICAL FIELD

The disclosure relates to the technical field of specialty gas purification, and more particularly to a porous adsorption material for removing neon from helium, and a preparation method and an application thereof.

### BACKGROUND

Helium (He) is a colorless and odorless inert gas, which has wide applications in numerous fields including semiconductors, healthcare, military industry, and aerospace, and He is an indispensable rare strategic resource for development of high-tech industries. With the rapid development of domestic high-tech industries, a market demand for high-purity helium is increasingly intensifying.

Due to an extremely low concentration of He in the air, which is only about 5 parts per million (ppm), it is difficult to produce helium effectively by using traditional air separation equipment. Therefore, at present, He is mainly obtained by progressively condensing natural gas to about −190 Celsius degrees (° C.) to obtain crude helium with a purity range of 70-90%, and then further purifying the crude helium to high-purity helium with a purity of 99.999% via cryogenic distillation. However, since a boiling point of He is very low (−268.9° C.), and a boiling point of neon (Ne), which is the main impurity in the crude helium, is also relatively low (−248.6° C.), a deep cooling method is required to separate Ne from He to produce high-purity helium. The deep cooling method is a production process with significant equipment investment and extremely high energy consumption. A cryogenic adsorption method allows for adsorption and removal of impurities such as Ne from He in a low-temperature environment, increasing He purity to 99.999%. This method can significantly improve production efficiency of He while greatly reducing production energy consumption.

A Chinese Patent Application No. 202311869986.1 (corresponding to patent publication No. CN117753170A) discloses a cryogenic pressure swing adsorption method for efficiently removing Ne and hydrogen (H₂) from He. According to this method, a feed gas containing He and impurity gases is processed through a designed pressure swing adsorption process, which can reduce concentrations of Ne and H₂ to below 4 ppm and 1 ppm, respectively. However, commercially available activated carbon adsorbents currently exhibit a low adsorption capacity for Ne, making it difficult to enhance production efficiency.

Porous carbon material offers advantages such as large specific surface area and pore volume, stable structure, and low production cost. The porous carbon material has broad application prospects in a field of gas separation and purification. Activated carbon is one of the more commonly used raw materials for existing cryogenic adsorbents, with a temperature of 60-77 kelvins (K) near a liquid nitrogen temperature range. The activated carbon has already been put into industrial application. However, powdered activated carbon typically possesses very high specific surface area and abundant microporous structure, which makes it excellent in gas adsorption. Yet, to convert the powdered activated carbon into easily processable block or granular material, it is usually necessary to add a binder. The binder may fill or cover micropores of the activated carbon, thereby reducing effective adsorption sites and lowering adsorption capacity and selectivity. Currently, most of the porous carbon materials used for producing high-purity helium are commercial activated carbons with wide pore size distribution, which leads to a low adsorption capacity for the inert gas Ne and significantly limits efficiency of producing the high-purity helium via the cryogenic adsorption method. Carbon-based adsorbents directly prepared by current methods available on the market often lack sufficient mechanical strength and are prone to be broken into powder during operation, leading to a decline in adsorption performance. Direct preparation methods may result in non-uniform pore size distribution, affecting selectivity and adsorption efficiency for specific gases. Consequently, the current cryogenic adsorption method still has problems of small adsorption capacities and low recovery rates. Furthermore, performance of current adsorbents under a low pressure cannot meet consumer demands.

Therefore, there is an urgent need for a porous carbon material with uniform pore size distribution and a high adsorption capacity for the inert gas Ne at low temperatures and a preparation method thereof.

### SUMMARY

Based on deficiencies of the related art, the purpose of the disclosure is to provide a porous carbon material with uniform pore size distribution and a high adsorption capacity for the inert gas neon at low temperatures, and a preparation method thereof.

To achieve the above purpose, the disclosure provides the following technical solutions.

A preparation method of a porous adsorption material for removing neon from helium includes the following steps.

(1) A lignin raw material is crushed to a size less than 200 mesh to obtain powder. 20-30 parts of the powder and 40-50 parts of deionized water in parts by weight are mixed to obtain a fermentation material. Mixed microorganisms are added to the fermentation material for aerobic fermentation, followed by filtering, drying, crushing, and sieving to obtain a fermented lignin raw material, where the mixed microorganisms include Bacillus licheniformis, Bacillus subtilis, and Rhizopus oryzae.

(2) 1 part by weight of the fermented lignin raw material and 10-12 parts by weight of a concentration of 1-1.2 moles per liter (mol/L) of hydrochloric acid (HCl) solution are mixed to obtain a first mixture. The first mixture is ultrasonically dispersed at a power of 90-100 watts (W) for 40-50 minutes, stirred at 80-85° C. at a speed of 600-650 revolutions per minute (rpm) for 25-30 hours (h) to obtain a first stirred mixture. Washing the first stirred mixture with deionized water until the first stirred mixture is neutral to obtain a neutral mixture, and performing vacuum drying on the neutral mixture in a vacuum drying oven at 80-90° C. for 24-28 h to obtain a carbon precursor.

(3) The carbon precursor is stirred and impregnated in a mixed solution containing a metal salt and a surfactant to obtain a metal salt-impregnated carbon precursor.

(4) The metal salt-impregnated carbon precursor is washed to remove a metal salt deposited in excess and dried to obtain a washed carbon precursor.

(5) The washed carbon precursor is activated with carbon dioxide to effect pore formation, thereby the porous adsorption material for removing neon from helium is obtained. The porous adsorption material is designated as MC.

In an embodiment, in the step (1), an amount of the Bacillus licheniformis is in a range of 10⁸-10⁹ colony-forming units per milliliter (CFU/mL) of the fermentation material; an amount of the Bacillus subtilis is in a range of 10⁶-10⁷ CFU/mL of the fermentation material; and an amount of the Rhizopus oryzae is in a range of 10⁶-10⁷ CFU/mL of the fermentation material.

The disclosure relates to the porous adsorption material prepared by first fermenting the lignin raw material with the mixed microorganisms, which improves a neon adsorption capacity of the porous adsorption material at a pressure of 10000 Pascals (Pa). During the aerobic fermentation, the Bacillus licheniformis, the Bacillus subtilis, and the Rhizopus oryzae can secrete various enzymes, which can partially degrade complex internal structure of the lignin raw material. After the fermentation treatment, molecular chains of the lignin raw material are partially broken and chemical bonds of the lignin raw material are cleaved, which alters structure of the lignin and provides more abundant microporous and mesoporous structure. Synergistic effect of these pores can significantly increase specific surface area of adsorption material. The larger specific surface area means more adsorption sites, thereby enhancing an adsorption capacity of the adsorption material for neon.

In an embodiment, the lignin raw material in the step (1) includes coconut shells, olive shells, and bamboo in a weight ratio of 1:(1.3-1.5):(0.5-0.7).

The neon adsorption capacity under a condition of 1000 Pa can be further improved when the coconut shells, the olive shells, and the bamboo in a specific ratio are used as the lignin raw material. This improvement is primarily attributed to difference in lignin content and structure among the coconut shells, the olive shells, and the bamboo. During fermentation and activation, the coconut shells tend to form larger mesopores and macropores, which facilitates diffusion and adsorption of gas molecules; the olive shells are more likely to form micropores, which can provide more high-energy adsorption sites, making it particularly suitable for adsorbing Ne; and the bamboo can form uniformly distributed micropores and mesopores. Diversity of pore structure helps to increase the specific surface area and the adsorption selectivity of the adsorption material. Complementarity of different raw materials, synergistic effect of microbial metabolites, optimized pore structure and adsorption sites, and improved mechanical strength and stability collectively contribute to enhance adsorption performance of the adsorption material under moderate partial pressure conditions. Improvements to the adsorption material not only increases the adsorption capacity but also enhances the adsorption selectivity and stability of the adsorption material.

The Bacillus licheniformis is purchased from Shanghai Preservation Microorganism Co., Ltd., with a product No. SHMCCD10742.

The Bacillus subtilis is purchased from Shanghai Preservation Microorganism Co., Ltd., with a product No. SHMCCD15537.

The Rhizopus oryzae is purchased from Shanghai Preservation Microorganism Co., Ltd., with a product No. SHMCCD10257.

In an embodiment, in the step (1), fermentation conditions are at 32-35° C. for 5-8 h.

In an embodiment, the surfactant in the step (3) includes sodium dodecylbenzenesulfonate, octadeyl dimethyl betaine, and a zwitterionic surfactant in a weight ratio of 1:(1.2-1.4):(0.3-0.5). Mass fraction of the surfactant in the mixed solution is in a range of 0.5-2.5%.

In an embodiment, a preparation method of the zwitterionic surfactant includes the following steps.

S1, a HCl aqueous solution is heated to 40-45° C. to obtain a heated HCl aqueous solution, and N,N-dimethylhexadecylamine is added dropwise to the heated HCl aqueous solution. A temperature of the heated HCl aqueous solution added with the N,N-dimethylhexadecylamine is maintained for reaction for 1-1.5 h to obtain a first reacted solution. Subsequently, an ethanol solution of epoxidized soybean oil is added dropwise to the first reacted solution, and a temperature of the first reacted solution added with the ethanol solution of epoxidized soybean oil is controlled at 50-55° C. to reach for 6-8 h to obtain a second reacted solution. Then ethanol and water from the second reacted solution are removed by distillation under reduced pressure to obtain an intermediate 1. A molar ratio of the N,N-dimethylhexadecylamine:HCl:the epoxidized soybean oil is 3:3:(0.8-1).

S2, 10 parts by weight of the intermediate 1 is dissolved in an ethanol aqueous solution, and 0.5-0.7 parts by weight of sodium hydroxide (NaOH) is added in the ethanol aqueous solution to obtain a second mixture, which is stirred under reflux for reaction for 4-6 h to obtain a second stirred mixture. Then the reaction is stopped. The second stirred mixture is filtered to obtain a filter residue, and the filter residue is washed with absolute ethanol for 3-4 times to obtain a washed filter residue. The washed filter residue is dried under vacuum to obtain the zwitterionic surfactant.

The disclosure can improve the adsorption capacity of neon at a low pressure (100 Pa) by adding the surfactant in a specific ratio to the impregnation solution. The addition of the surfactant used in the disclosure can act as a dispersing agent during deposition of the metal salt, which prevents aggregation of metal salt particles and ensures uniform distribution of the metal salt particles on surface and within pores of the carbon precursor prepared in the disclosure. Optimization of the pore structure, an increase in adsorption sites, and an improvement in the adsorption selectivity are further achieved, which is conducive to maintaining openness of the pores and avoiding pore blockage.

In an embodiment, in the step (3), the metal salt is one or more selected from the group consisting of a sodium salt, a potassium salt, a magnesium salt, and a zinc salt.

In an embodiment, in the step (3), a concentration of the metal salt in the mixed solution is in a range of 1-5 mol/L.

In an embodiment, in the step (3), conditions for the stirring and the impregnating include an impregnation time of 20-24 h, a temperature of 60-80° C., and a stirring speed of 200-300 rpm.

In an embodiment, in the step (3), an impregnation solid-to-liquid ratio of the carbon precursor to the mixed solution is in a range from 1 gram (g): 15 milliliters (mL) to 1 g: 20 mL (also referred to as 1:15 to 1:20 gram per milliliter (g/mL)).

In an embodiment, in the step (5), the activating and pore-forming includes heating the washed carbon precursor to obtain a heated carbon precursor, and activating the heated carbon precursor with the carbon dioxide to effect pore formation, where a heating rate is in a range of 5-10 Celsius degrees per minute (° C./min), an activation temperature is in a range of 800-1000° C., an activation duration is in a range of 80-100 minutes, and a concentration of the carbon dioxide is in a range of 80-100%.

The disclosure provides the porous adsorption material for removing neon from helium, obtained by the preparation method.

Compared with the related art, the disclosure exhibits the following advantages and technical effects.

(1) The disclosure utilizes the bamboo, the coconut shells, and the olive shells containing lignin as carbon sources, and uses an in-situ directional activation and pore-forming method by metal ions. During physical activation and pore-forming process, highly dispersed metal ions are utilized to perform in-situ etching activation on the porous carbon material, thereby controlling the activation and pore-forming reaction of the porous carbon material, resulting in the porous carbon adsorption material with uniform pore size distribution. This material exhibits a high adsorption and capture capacity for neon under low-temperature conditions, and can effectively remove neon impurities from helium.

(2) The disclosure provides the porous adsorption material for removing neon from helium, which uses natural biomass materials as carbon sources, offering environmental friendliness, renewability, and low production cost. The adsorption material in the disclosure utilizes the in-situ directional activation and pore-forming by metal ions to precisely etch and form uniform pores on the carbon material. Compared with commercial activated carbon, the adsorption material in the disclosure has more uniform pore size distribution, thereby imparting enhanced an adsorption capacity for neon.

(3) The disclosure relates to the porous adsorption material prepared by first fermenting the lignin raw material with the mixed microorganisms, which improves the neon adsorption capacity of the porous adsorption material at the pressure of 10000 Pa. Compared with existing adsorption materials, the adsorption material of the disclosure can achieve the neon adsorption capacity of 0.87 millimoles per gram (mmol/g) for neon at 0.1 bar under low temperatures, which is significantly higher than commercial coconut shell activated carbon CTC-100 with a neon adsorption capacity of 0.45 mmol/g.

(4) The neon adsorption capacity under the condition of 1000 Pa can be further improved when the coconut shells, the olive shells, and the bamboo in a specific ratio are used as the lignin raw material.

(5) The disclosure can improve the adsorption capacity of neon at a low pressure (100 Pa) by adding the surfactant in the specific ratio to the impregnation solution. The adsorption material in the disclosure can exhibit excellent adsorption performance under low-temperature and low-pressure conditions.

### BRIEF DESCRIPTION OF DRAWINGS

FIG. 1 illustrates a diagram of typical pore size distribution of commercial coconut shell activated carbon CTC-100 and an adsorption material obtained in an embodiment 4.

FIG. 2 illustrates a schematic diagram of adsorption isotherms of propane (C₃H₈) and methyl fluoride (CH₃F) at a temperature of 298 K for the commercial coconut shell activated carbon CTC-100 and adsorption materials obtained in embodiments 1-5 of the disclosure. In the FIG. 2, MC-1 represents a porous adsorption material prepared in an embodiment 1; MC-2 represents a porous adsorption material prepared in an embodiment 2; MC-3 represents a porous adsorption material prepared in an embodiment 3; MC-4 represents a porous adsorption material prepared in the embodiment 4; and MC-5 represents a porous adsorption material prepared in an embodiment 5.

### DETAILED DESCRIPTION OF EMBODIMENTS

The following further illustrates the disclosure in conjunction with the attached drawings and embodiments. However, the scope for protection claimed by the disclosure is not limited to the scope described in the embodiments.

Raw materials used in the disclosure are all commercially available products.

Bacillus licheniformis is purchased from Shanghai Preservation Microorganism Co., Ltd., with a product No. SHMCCD10742.

Bacillus subtilis is purchased from Shanghai Preservation Microorganism Co., Ltd., with a product No. SHMCCD15537.

Rhizopus oryzae is purchased from Shanghai Preservation Microorganism Co., Ltd., with a product No. SHMCCD10257.

Epoxidized soybean oil is purchased from Shandong Kexing Chemical Co., Ltd., which is industrial-grade epoxidized soybean oil.

Aspergillus niger is purchased from Shanghai Preservation Microorganism Co., Ltd., with a product No. SHMCCD11656.

Candida utilis is purchased from Wuhan Huizao Biotechnology Co., Ltd., with a product No. HZB119504.

### Embodiment 1

Embodiment 1 provides a preparation method of a porous adsorption material for removing neon from helium. The preparation method includes the following steps.

(1) A lignin raw material is crushed to a size less than 200 mesh to obtain powder. 20 parts of the powder and 50 parts of deionized water in parts by weight are mixed to obtain a fermentation material. Mixed microorganisms are added to the fermentation material for aerobic fermentation at 32° C. for 8 h, followed by filtering, drying, and crushing to obtain crushed powder. The crushed powder is sieved between 100 and 200 mesh to obtain a fermented lignin raw material. The mixed microorganisms include Bacillus licheniformis, Bacillus subtilis, and Rhizopus oryzae.

The lignin raw material includes coconut shells, olive shells, and bamboo in a weight ratio of 1:1.3:0.5.

An amount of the Bacillus licheniformis is 10⁸ CFU/mL of the fermentation material; an amount of the Bacillus subtilis is 10⁷ CFU/mL of the fermentation material; and an amount of the Rhizopus oryzae is 10⁶ CFU/mL of the fermentation material.

(2) 1 part by weight of the fermented lignin raw material and 12 parts by weight of HCl solution with a concentration of 1 mol/L are mixed to obtain a first mixture. The first mixture is ultrasonically dispersed at a power of 100 W for 40 minutes, stirred at 85° C. at a speed of 600 rpm for 30 h to obtain a first stirred mixture. The first stirred mixture is washed with deionized water until the first stirred mixture is neutral to obtain a neutral mixture. Vacuum drying is performed on the neutral mixture in a vacuum drying oven at 80° C. for 28 h to obtain a carbon precursor.

(3) The carbon precursor is stirred and impregnated in a mixed solution containing a metal salt and a surfactant. Conditions for the stirring and the impregnating include an impregnation time of 20 h, a temperature of 80° C., and a stirring speed of 200 rpm. An impregnation solid-to-liquid ratio of the carbon precursor with the mixed solution is 1 g: 15 mL to obtain a metal salt-impregnated carbon precursor.

The metal salt is potassium chloride. A concentration of the metal salt in the mixed solution is 5 mol/L. The surfactant includes sodium dodecylbenzenesulfonate, octadeyl dimethyl betaine, and a zwitterionic surfactant in a weight ratio of 1:1.2:0.3. A mass fraction of the surfactant in the mixed solution is 1%. Remaining volume of the mixed solution is water.

A preparation method of the zwitterionic surfactant includes the following steps.

S1, a HCl aqueous solution with a volume of 100 mL and a concentration of 5.5 mol/L is heated to 40° C. to obtain a heated HCl aqueous solution. 0.5 moles (mol) of N,N-dimethylhexadecylamine is added dropwise to the heated HCl aqueous solution. A temperature of the heated HCl aqueous solution added with the N,N-dimethylhexadecylamine is maintained for reaction for 1.5 h to obtain a first reacted solution. Subsequently 1.5 mol of ethanol solution of epoxidized soybean oil with a volume fraction of 55% is added dropwise to the first reacted solution. A temperature of the first reacted solution added with the ethanol solution of epoxidized soybean oil is controlled at 55° C. to react for 6 h to obtain a second reacted solution. Then ethanol and water from the second reacted solution are removed by distillation under reduced pressure to obtain an intermediate 1.

S2, 10 g of the intermediate 1 is dissolved in an ethanol aqueous solution with a volume of 220 mL and a volume fraction of 90%, and 0.7 g of NaOH is added in the ethanol aqueous solution to obtain a second mixture, which is stirred under reflux for reaction for 4 h to obtain a second stirred mixture. Then, the reaction is stopped. The second stirred mixture is filtered to obtain a filter residue. The filter residue is washed with absolute ethanol for 3 times to obtain a washed filter residue. The washed filter residue is dried under vacuum to obtain the zwitterionic surfactant.

(4) The metal salt-impregnated carbon precursor is washed with water to remove a metal salt deposited in excess and dried to obtain a washed carbon precursor.

(5) The washed carbon precursor is activated with carbon dioxide to effect pore formation at a heating rate of 10° C./min, an activation temperature of 800° C., an activation duration of 100 minutes, and a carbon dioxide concentration of 80% to obtain the porous adsorption material for removing neon from helium.

### Embodiment 2

Difference between embodiment 2 and the embodiment 1 is that the surfactant in the step (3) includes sodium dodecylbenzenesulfonate, octadeyl dimethyl betaine, and a zwitterionic surfactant in a weight ratio of 1:1.2:0.3. The preparation method of zwitterionic surfactant is the same as that of the embodiment 1.

### Embodiment 3

Difference between embodiment 3 and the embodiment 1 is that the lignin raw material includes coconut shells, olive shells, and bamboo in a weight ratio of 1:1.3:0.5.

### Embodiment 4

Embodiment 4 provides a preparation method of a porous adsorption material for removing neon from helium. The preparation method includes the following steps.

(1) A lignin raw material is crushed to a size less than 200 mesh to obtain powder. 25 parts of the powder and 45 parts of deionized water in parts by weight are mixed to obtain a fermentation material. Mixed microorganisms are added to the fermentation material for aerobic fermentation at 33° C. for 6 h, followed by filtering, drying, and crushing to obtain crushed powder. The crushed powder is sieved between 100 and 200 mesh to obtain a fermented lignin raw material. The mixed microorganisms include Bacillus licheniformis, Bacillus subtilis, and Rhizopus oryzae.

The lignin raw material includes coconut shells, olive shells, and bamboo in a weight ratio of 1:1.4:0.6.

An amount of the Bacillus licheniformis is 10⁸ CFU/mL of the fermentation material; an amount of the Bacillus subtilis is 10⁷ CFU/mL of the fermentation material; and an amount of the Rhizopus oryzae is 10⁶ CFU/mL of the fermentation material.

(2) 1 part by weight of the fermented lignin raw material and 11 parts by weight of HCl solution with a concentration of 1.1 mol/L are mixed to obtain a first mixture. The first mixture is ultrasonically dispersed at a power of 95 W for 45 minutes, stirred at 82° C. at a speed of 620 rpm for 27 h to obtain a first stirred mixture. The first stirred mixture is washed with deionized water until the first stirred mixture is neutral to obtain a neutral mixture. Vacuum drying is performed on the neutral mixture in a vacuum drying oven at 85° C. for 26 h to obtain a carbon precursor.

(3) The carbon precursor is stirred and impregnated in a mixed solution containing a metal salt and a surfactant. Conditions for the stirring and the impregnating include an impregnation time of 22 h, a temperature of 70° C., and a stirring speed of 250 rpm. An impregnation solid-to-liquid ratio of the carbon precursor with the mixed solution is 1 g: 18 mL to obtain a metal salt-impregnated carbon precursor.

The metal salt is sodium chloride. A concentration of the metal salt in the mixed solution is 2 mol/L.

The surfactant includes sodium dodecylbenzenesulfonate, octadeyl dimethyl betaine, and a zwitterionic surfactant in a weight ratio of 1:1.3:0.4. A mass fraction of the surfactant in the mixed solution is 2%.

A preparation method of the zwitterionic surfactant includes the following steps.

S1, a HCl aqueous solution with a volume of 100 mL and a concentration of 5.2 mol/L is heated to 42° C. to obtain a heated HCl aqueous solution. 0.5 mol of N,N-dimethylhexadecylamine is added dropwise to the heated HCl aqueous solution. A temperature of the heated HCl aqueous solution added with the N,N-dimethylhexadecylamine is maintained for reaction for 1.2 h to obtain a first reacted solution. Subsequently, 1.5 mol of ethanol solution of epoxidized soybean oil with a volume fraction of 58% is added dropwise to the first reacted solution. A temperature of the first reacted solution added with the ethanol solution of epoxidized soybean oil is controlled at 52° C. to react for 7 h to obtain a second reacted solution. Then ethanol and water from the second reacted solution are removed by distillation under reduced pressure to obtain an intermediate 1.

S2, 10 g of the intermediate 1 is dissolved in an ethanol aqueous solution with a volume of 210 mL and a volume fraction of 92%, and 0.6 g of NaOH is added in the ethanol aqueous solution to obtain a second mixture, which is stirred under reflux for reaction for 5 h to obtain a second stirred mixture. Then the reaction is stopped. The second stirred mixture is filtered to obtain a filter residue. A filter residue is washed with absolute ethanol for 4 times to obtain a washed filter residue. The washed filter residue is dried under vacuum to obtain the zwitterionic surfactant.

(4) The metal salt-impregnated carbon precursor is washed with water to remove a metal salt deposited in excess and dried to obtain a washed carbon precursor.

(5) The washed carbon precursor is activated with carbon dioxide to effect pore formation at a heating rate of 7° C./min, an activation temperature of 900° C., an activation duration of 90 minutes, and a carbon dioxide concentration of 90% to obtain the porous adsorption material for removing neon from helium.

### Embodiment 5

Difference between embodiment 5 and the embodiment 1 is that, in the step (1), an amount of the Bacillus licheniformis is 10⁹ CFU/mL of the fermentation material; an amount of the Bacillus subtilis is 10⁷ CFU/mL of the fermentation material; and an amount of the Rhizopus oryzae is 10⁷ CFU/mL of the fermentation material.

### Comparative Example 1

Difference between comparative example 1 and the embodiment 4 is that the surfactant in the step (3) includes sodium dodecylbenzenesulfonate, octadeyl dimethyl betaine, and a zwitterionic surfactant in a weight ratio of 1:1:1. The preparation method of the zwitterionic surfactant is the same as that of the embodiment 1.

### Comparative Example 2

Difference between comparative example 2 and the embodiment 4 is that the surfactant in the step (3) includes sodium fatty alcohol polyoxyethylene ether sulfate (purchased from Jinan Saijia Chemical Co., Ltd.), ammonium monococoate sulfate (CAS: 61789 Mar. 5), and sodium dodecyl sulfate in a weight ratio of 1:1.2:0.3.

### Comparative Example 3

Difference between comparative example 3 and the embodiment 4 is that the mixed microorganisms include Candida utilis, Bacillus subtilis, and Aspergillus niger. An amount of the Candida utilis is 10⁸ CFU/mL of the fermentation material; an amount of the Bacillus subtilis is 10⁷ CFU/mL of the fermentation material; and an amount of the Aspergillus niger is 10⁶ CFU/mL of the fermentation material.

### Comparative Example 4

Difference between comparative example 4 and the embodiment 4 is that conditions for the stirring and the impregnating include an impregnation time of 15 h, a temperature of 85° C., and a stirring speed of 400 rpm. An impregnation solid-to-liquid ratio of the carbon precursor to the mixed solution is 1 g: 10 mL.

### Comparative Example 5

Difference between comparative example 5 and the embodiment 4 is that, in the step (5), the high-temperature activation uses a heating rate of 15° C./min, an activation temperature of 600° C., an activation duration of 60 minutes, and carbon dioxide concentration of 50%.

### Comparative Example 6

Difference between comparative example 6 and the embodiment 4 is that no fermentation treatment is carried out in the comparative example 6.

(1) 1 part by weight of a lignin raw material and 11 parts by weight of HCl solution with a concentration of 1.1 mol/L are mixed to obtain a first mixture. The first mixture is ultrasonically dispersed at a power of 95 W for 45 minutes, stirred at 82° C. at a speed of 620 rpm for 27 h to obtain a first stirred mixture. The first stirred mixture is washed with deionized water until the first stirred mixture is neutral to obtain a neutral mixture. Vacuum drying is performed on the neutral mixture in a vacuum drying oven at 85° C. for 26 h to obtain a carbon precursor.

(2) The carbon precursor is stirred and impregnated in a mixed solution containing a metal salt and a surfactant. Conditions for the stirring and the impregnating include an impregnation time of 22 h, a temperature of 70° C., and a stirring speed of 250 rpm. An impregnation solid-to-liquid ratio of the carbon precursor with the mixed solution is 1 g: 18 mL to obtain a metal salt-impregnated carbon precursor.

The metal salt is sodium chloride. A concentration of the metal salt in the mixed solution is 2 mol/L.

The surfactant includes sodium dodecylbenzenesulfonate, octadeyl dimethyl betaine, and a zwitterionic surfactant in a weight ratio of 1:1.3:0.4.

A preparation method of the zwitterionic surfactant includes the following steps.

S1, a HCl aqueous solution with a volume of 100 mL and a concentration of 5.2 mol/L is heated to 42° C. to obtain a heated HCl aqueous solution. 0.5 mol of N,N-dimethylhexadecylamine is added dropwise to the heated HCl aqueous solution. A temperature of the heated HCl aqueous solution added with the N,N-dimethylhexadecylamine is maintained for reaction for 1.2 h to obtain a first reacted solution. Subsequently, 1.5 mol of ethanol solution of epoxidized soybean oil with a volume fraction of 58% is added dropwise to the first reacted solution. A temperature of the first reacted solution added with the ethanol solution of epoxidized soybean oil is controlled at 52° C. to react for 7 h to obtain a second reacted solution. Then, ethanol and water from the second reacted solution are removed by distillation under reduced pressure to obtain an intermediate 1.

S2, 10 g of the intermediate 1 is dissolved in an ethanol aqueous solution with a volume of 210 mL and a volume fraction of 92%, and 0.6 g of NaOH is added in the ethanol aqueous solution to obtain a second mixture, which is stirred under reflux for reaction for 5 h to obtain a second stirred mixture. Then, the reaction is stopped. The second stirred mixture is filtered to obtain a filter residue. The filter residue is washed with absolute ethanol for 4 times to obtain a washed filter residue. The washed filter residue is dried under vacuum to obtain the zwitterionic surfactant.

(3) The metal salt-impregnated carbon precursor is washed with water to remove a metal salt deposited in excess and dried to obtain a washed carbon precursor.

(4) The washed carbon precursor is activated with carbon dioxide to effect pore formation at a heating rate of 7° C./min, an activation temperature of 900° C., an activation duration of 90 minutes, and a carbon dioxide concentration of 90% to obtain the porous adsorption material for removing neon from helium.

### Performance Test

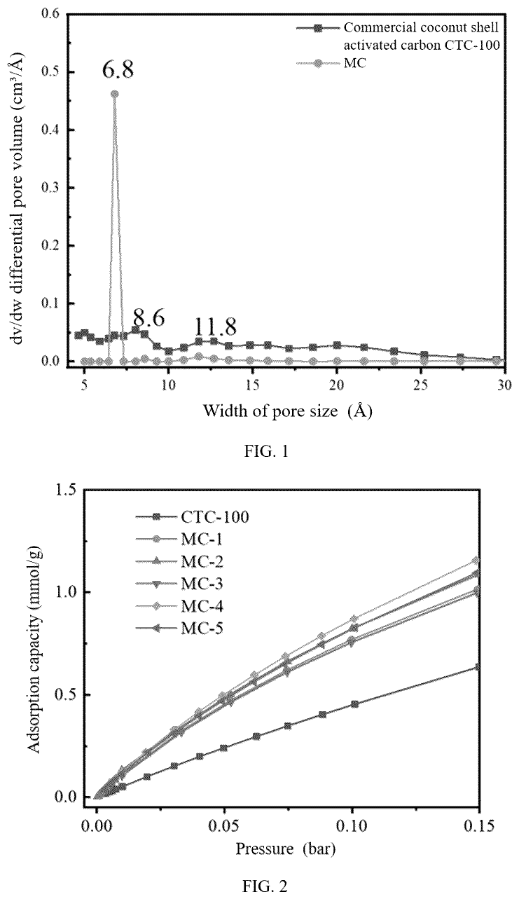

1. ASAP 2460 multi-station fully automated specific surface area and porosimetry analyzer of Micromeritics Instrument Corporation is used to analyze pore size distribution of commercial coconut shell activated carbon CTC-100 and the porous adsorption material MC obtained in the embodiment 4. Results are illustrated in the FIG. 1. The results illustrate that the pore sizes of the porous adsorption material MC obtained in the embodiment 4 of the disclosure are mainly concentrated at 6.8 angstroms (Å). By using highly dispersed metal ions, the carbon material can be etched directionally and pore-formed, so that the obtained porous carbon adsorption material MC possesses uniform and concentrated pore size distribution, and exhibits an excellent adsorption capacity for neon.

2. 3Flex high-performance gas adsorption analyzer of Micromeritics Instrument Corporation is used to measure neon adsorption capacities for the commercial coconut shell activated carbon CTC-100 and the porous carbon adsorption materials obtained in the embodiments 1-5 and the comparative examples 1-6 at partial pressures of 10000 Pa, 1000 Pa, and 100 Pa under 77 K. Neon adsorption isotherms for the embodiments 1-5 are also measured. Results are illustrated in Table 1 and the FIG. 2.

TABLE 1
Neon adsorption capacity test results at 77 K (mmol/g)

| | 10000 Pa | 1000 Pa | 100 Pa |
|---|---|---|---|
| Embodiment 1 | 0.77 | 0.017 | 0.0055 |
| Embodiment 2 | 0.82 | 0.015 | 0.0058 |
| Embodiment 3 | 0.76 | 0.016 | 0.0054 |
| Embodiment 4 | 0.87 | 0.020 | 0.0064 |
| Embodiment 5 | 0.82 | 0.018 | 0.0056 |
| Comparative example 1 | 0.72 | 0.011 | 0.0045 |
| Comparative example 2 | 0.71 | 0.010 | 0.0042 |
| Comparative example 3 | 0.70 | 0.009 | 0.0041 |
| Comparative example 4 | 0.74 | 0.013 | 0.0049 |
| Comparative example 5 | 0.72 | 0.012 | 0.0046 |
| Comparative example 6 | 0.66 | 0.007 | 0.0038 |
| CTC-100 | 0.45 | 0.004 | 0.0022 |

The results illustrate that the neon adsorption capacities of the porous carbon adsorption materials obtained in the embodiments 1-5 are higher than that of the commercial coconut shell activated carbon CTC-100 under the different partial pressures. In particular, the porous carbon adsorption material obtained in the embodiment 4 exhibits a best overall adsorption effect.

In contrast, due to a failure to adopt necessary technical solutions in the comparative examples, the neon adsorption capacities of the porous carbon adsorption materials are significantly inferior to the embodiments in the corresponding performance tests. In the comparative example 1, the ratio of the surfactant is changed. In the comparative example 2, a type of the surfactant is changed. It can be seen that the adsorption capacity for neon at a low pressure (100 Pa) has decreased. In the comparative example 3, a type of the mixed microorganisms used is different. In the comparative example 6, the neon adsorption capacity of the porous adsorption material under a condition of 10000 Pa has decreased without fermentation treatment. In the comparative example 4, with the different conditions for the stirring and the impregnating, the adsorption capacities under different pressures all have decreased, illustrating that the conditions for the stirring and the impregnating affect an effectiveness of in-situ directional activation and pore-forming by metal ions. In the comparative example 5, with the different high-temperature activation conditions, the adsorption capacities under the different pressures all have decreased, illustrating that the high-temperature activation conditions affect structure of the porous adsorption material, thereby influencing adsorption effects. The above experimental results further demonstrate an importance of the technical solutions defined in the disclosure for achieving its technical effects.

The foregoing descriptions are merely illustrated embodiments of the disclosure. It should be noted that several improvements and modifications can be made by skilled in the related art without departing from the principles of the disclosure. These improvements and modifications should also be considered within the scope of protection of the disclosure.

What is claimed is:

1. A preparation method of a porous adsorption material for removing neon from helium, comprising:
(1) crushing a lignin raw material to obtain powder; mixing 20-30 parts of the powder with 40-50 parts of deionized water in parts by weight to obtain a fermentation material, adding mixed microorganisms to the fermentation material for aerobic fermentation, followed by filtering, drying, crushing, and sieving to obtain a fermented lignin raw material; wherein the mixed microorganisms comprise Bacillus licheniformis, Bacillus subtilis, and Rhizopus oryzae;
and the lignin raw material comprises coconut shells, olive shells, and bamboo in a weight ratio of 1:(1.3-1.5):(0.5-0.7);
(2) mixing 1 part by weight of the fermented lignin raw material with 10-12 parts by weight of hydrochloric acid (HCl) solution to obtain a first mixture, ultrasonically dispersing the first mixture for 40-50 minutes to obtain a dispersed mixture, stirring the dispersed mixture at 80-85 Celsius degrees (° C.) for 25-30 hours (h) to obtain a first stirred mixture, washing the first stirred mixture with deionized water until the first stirred mixture is neutral to obtain a neutral mixture, and performing vacuum drying on the neutral mixture to obtain a carbon precursor;
(3) stirring and impregnating the carbon precursor in a mixed solution containing a metal salt and a surfactant to obtain a metal salt-impregnated carbon precursor; wherein the metal salt is one or more selected from the group consisting of a sodium salt, a potassium salt, a magnesium salt, and a zinc salt; the surfactant comprises sodium dodecylbenzenesulfonate, octadeyl dimethyl betaine, and a zwitterionic surfactant in a weight ratio of 1:(1.2-1.4):(0.3-0.5); conditions for the stirring and the impregnating comprise an impregnation time of 20-24 h, a temperature of 60-80° C., and a stirring speed of 200-300 revolutions per minute (rpm); and an impregnation solid-to-liquid ratio of the carbon precursor to the mixed solution is in a range from 1:15 to 1:20 gram per milliliter (g/mL);
wherein a preparation method of the zwitterionic surfactant comprises the following steps: S1, heating a HCl aqueous solution to 40-45° C. to obtain a heated HCl aqueous solution, adding N,N-dimethylhexadecylamine dropwise to the heated HCl aqueous solution, maintaining a temperature of the heated HCl aqueous solution added with the N,N-dimethylhexadecylamine for reaction for 1-1.5 h to obtain a first reacted solution, adding an ethanol solution of epoxidized soybean oil dropwise to the first reacted solution, controlling a temperature of the first reacted solution added with the ethanol solution of epoxidized soybean oil at 50-55° C. to react for 6-8 h to obtain a second reacted solution, and removing ethanol and water from the second reacted solution by distillation under reduced pressure to obtain an intermediate 1; wherein a molar ratio of the N,N-dimethylhexadecylamine:HCl: the epoxidized soybean oil is 3:3:(0.8-1); and S2, dissolving 10 parts by weight of the intermediate 1 in an ethanol aqueous solution, and adding 0.5-0.7 parts by weight of sodium hydroxide (NaOH) in the ethanol aqueous solution to obtain a second mixture; stirring the second mixture under reflux for reaction for 4-6 h to obtain a second stirred mixture, stopping the reaction, filtering the second stirred mixture to obtain a filter residue, washing the filter residue with absolute ethanol to obtain a washed filter residue, and drying the washed filter residue under vacuum to obtain the zwitterionic surfactant;
(4) washing the metal salt-impregnated carbon precursor to remove a metal salt deposited in excess, followed by drying to obtain a washed carbon precursor; and
(5) activating the washed carbon precursor with carbon dioxide to effect pore formation, thereby obtaining the porous adsorption material for removing neon from helium; wherein the activating the washed carbon precursor with carbon dioxide to effect pore formation comprises heating the washed carbon precursor to obtain a heated carbon precursor, and activating the heated carbon precursor with the carbon dioxide to effect pore formation, wherein a heating rate is in a range of 5-10 Celsius degrees per minute (C/min), an activation temperature is in a range of 800-1000° C., an activation duration is in a range of 80-100 minutes, and a concentration of the carbon dioxide is in a range of 80-100%.

2. The preparation method of the porous adsorption material for removing neon from helium as claimed in claim 1, wherein in the step (1), an amount of the Bacillus licheniformis is in a range of 10⁸-10⁹ colony-forming units per milliliter (CFU/mL) of the fermentation material; an amount of the Bacillus subtilis is in a range of 10⁶-10⁷ CFU/mL of the fermentation material; and an amount of the Rhizopus oryzae is in a range of 10⁶-10⁷ CFU/mL of the fermentation material.

3. The preparation method of the porous adsorption material for removing neon from helium as claimed in claim 1, wherein in the step (1), fermentation conditions are at 32-35° C. for 5-8 h.

4. The preparation method of the porous adsorption material for removing neon from helium as claimed in claim 1, wherein a concentration of the metal salt in the mixed solution is in a range of 1-5 mole per liter (mol/L).
